(19) United States
(12) Patent Application Publication
(10) Pub. No.: US 2007/0246411 A1
(43) Pub. Date: Oct. 25, 2007

(54) Pollution-reducer device, a motor vehicle fitted with such a device, and a corresponding pipe

(76) Inventor: Pierre Milhas, Vitry-Le-Francois (FR)

Correspondence Address: DYKEMA GOSSETT PLLC, Ste. 300, 39577 Woodward Ave., Bloomfield Hills, MI, 48304-2820, US

(21) Appl. No.: 11/789,753

(22) Filed: Apr. 25, 2007

(30) Foreign Application Priority Data
Apr. 25, 2006 (FR) 06 03653

(51) Int. Cl. B01D 33/70

(52) U.S. Cl. 210/151

(57) ABSTRACT

The present invention relates to a pollution-reducer device comprising a tank of depollution fluid connected by a pipe to an injector member for injecting the fluid into a catalyst of a burnt-gas exhaust line, wherein the pipe comprises an outer tube receiving a compressible member that is compressible by a ratio that is suitable for compensating an increase in pressure exerted by the fluid on the pipe. The invention also relates to a motor vehicle fitted with such a device, and to a corresponding pipe.

### BACKGROUND OF THE INVENTION

The present invention relates to a device for reducing motor vehicle pollution, to a motor vehicle including such a device, and to a corresponding pipe for transporting a depollution fluid. The invention is applicable to any type of motor vehicle, and in particular to trucks, private cars, etc.

Anti-pollution systems have become very widespread on motor vehicles for the purpose of reducing polluting emissions therefrom. Such anti-pollution systems include catalytic converters as are now required for most vehicles. Nevertheless, environmental standards have lowered the maximum acceptable level of nitrogen compound emissions (NOx). A catalytic converter on its own turns out to be insufficient for obtaining such a reduction in the emissions of those compounds.

Proposals have therefore been made to inject into the catalytic converter a solution that results from a mixture of urea and water in order to generate redox reactions in the catalytic converter with the nitrogen-containing compound. That technology is implemented in so-called selective catalytic reduction (SCR) pollution-reducer devices. Transporting a solution in a motor vehicle is difficult because of the sensitivity of the solution to temperature: the solution decomposes above 70° C., giving off ammonia, and it freezes at −7° C., with the solidification of the solution leading to its volume expanding. The pipe used for transporting the solution must therefore be capable of withstanding it chemically and of accommodating large variations in dimensions. The tubes presently in use include fluorinated materials as an inner layer for coming into contact with the solution and they incorporate heater systems in order to avoid the solution freezing or in order to liquefy the solution if it has frozen. The tubes are also reinforced so as to withstand expansion of the solution as can result in particular on freezing. Such pipes are therefore very expensive, relatively inflexible, and bulky. That increases the cost and the size of pollution-reducer devices themselves.

### OBJECT OF THE INVENTION

It would therefore be advantageous to have means for reducing the cost of such a pollution-reducer device.

### SUMMARY OF THE INVENTION

To this end, the invention provides a pollution-reducer device comprising a tank of depollution fluid connected by a pipe to an injector member for injecting the fluid into a catalyst of a burnt-gas exhaust line, wherein the pipe comprises an outer tube receiving a compressible member that is compressible by a ratio that is suitable for compensating an increase in pressure exerted by the fluid on the pipe.

Thus, when the fluid pressure increases, the fluid causes the volume of the compressible member to decrease, so that the pressure exerted on the outer tube remains relatively limited, thus enabling the outer tube to conserve dimensions that are substantially unchanged. The compressible member can also serve to damp fluid pulsation, deformation of the compressible member reducing the amplitude of the pressure wave that results from a pressure peak.

In a particular embodiment, the pipe includes an inner tube extending coaxially inside the outer tube, the inner and outer tubes having diameters suitable for leaving a fluid flow space between them, the inner tube having an outside surface that is compatible with the transported fluid and the inner tube being more flexible than the outer tube so as to deform in order to compensate for an expansion of the fluid.

The inner tube constitutes a compressible member extending over the entire length of the outer tube, so it does not disturb the flow of fluid and can have a section that is relatively small, with the reduction in volume caused by the expansion of the fluid leading to a reduction in its section that is distributed over the entire length of the inner tube.

In various embodiments:

the inner tube is made of a thermoplastic material, e.g. polypropylene and ethylene-propylene-diene monomer; or

the inner tube is made of elastomer material, e.g. based on silicone.

This provides the inner tube with good capacity for deforming.

Advantageously, the outer tube is made of a thermoplastic material, and preferably of a material selected from the following: polyethylene; polyamide; and a mixture of polypropylene and ethylene-propylene-diene monomer; or the outer tube comprises an inner layer of high density polyethylene, an intermediate layer of maleic anhydride grafted polyethylene, and an outer layer of polyamide.

In the multilayer version, polyethylene constitutes a barrier to urea and to the ammonia that results from the urea decomposing or degrading, and it also withstands them chemically. This ensures that an odor of ammonia is not given off by the device and is not perceptible to the user. In addition, any risk of the pipe corroding is eliminated. The polyamide gives the pipe its mechanical strength.

In a particular embodiment, the pipe has ends connected respectively to a fluid emitter device and to a fluid receiver device so that the fluid flows in the space that extends between the tubes and so that the inner tube is open.

Thus, during compression of the inner tube under the effect of the fluid expanding, the air contained in the inner tube can escape.

Advantageously, at least one of the ends of the pipe is fitted with a coupling comprising a tubular body having one end arranged to co-operate with the corresponding end of the outer tube, and an opposite end closed by a radial partition, a bushing extending coaxially inside the body and having one end secured to the partition and opening to the outside of the coupling, and an opposite end arranged to co-operate with the corresponding end of the inner tube in such a manner as to put the flow space of the pipe into communication with an annular space defined by the body and the bushing, the coupling including coupling means for connecting said annular space with the element.

The pipe is then connected in simple and reliable manner, serving both to seal transport of the fluid and to allow air in the inner tube to escape to the outside.

The invention also provides a motor vehicle having a combustion engine with a burnt-gas exhaust line provided with a catalyst and a pollution-reducer device presenting at least one of the above characteristics.

The invention also provides a pipe for a pollution-reducer device that presents at least one of the above characteristics.

Preferably, the pipe is arranged to be rigid and shapeable by thermoforming.

This method of manufacture is inexpensive and simplifies installing the pipe under the body of a vehicle.

Other characteristics and advantages of the invention appear on reading the following description of a particular, non-limiting embodiment of the invention.

### BRIEF DESCRIPTION OF THE DRAWINGS

Reference is made to the accompanying drawings, in which:

FIG. 1 is a diagrammatic view of a motor vehicle of the invention; and

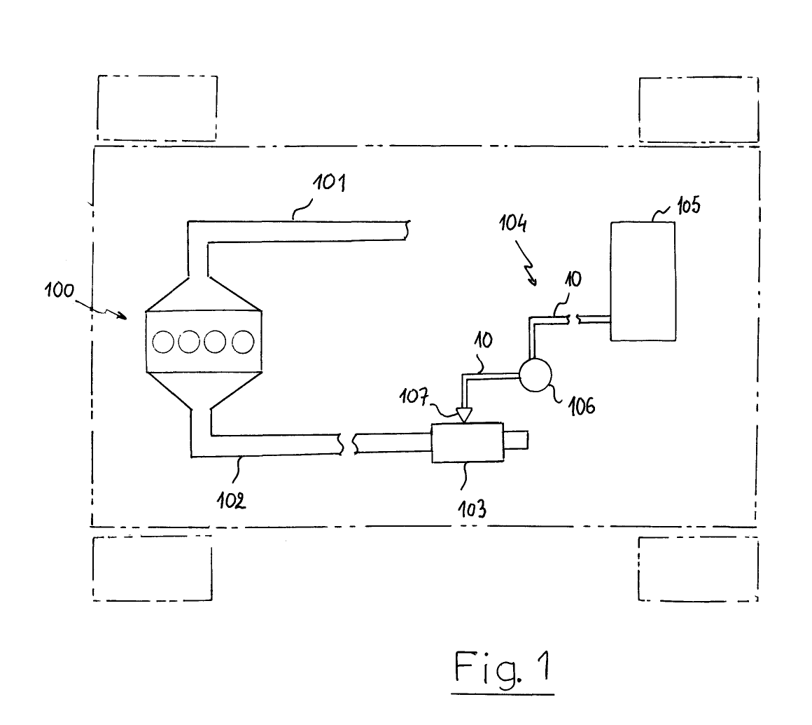

FIG. 2 is a longitudinal section view of a circuit segment of the pollution-reducer device in accordance with the invention.

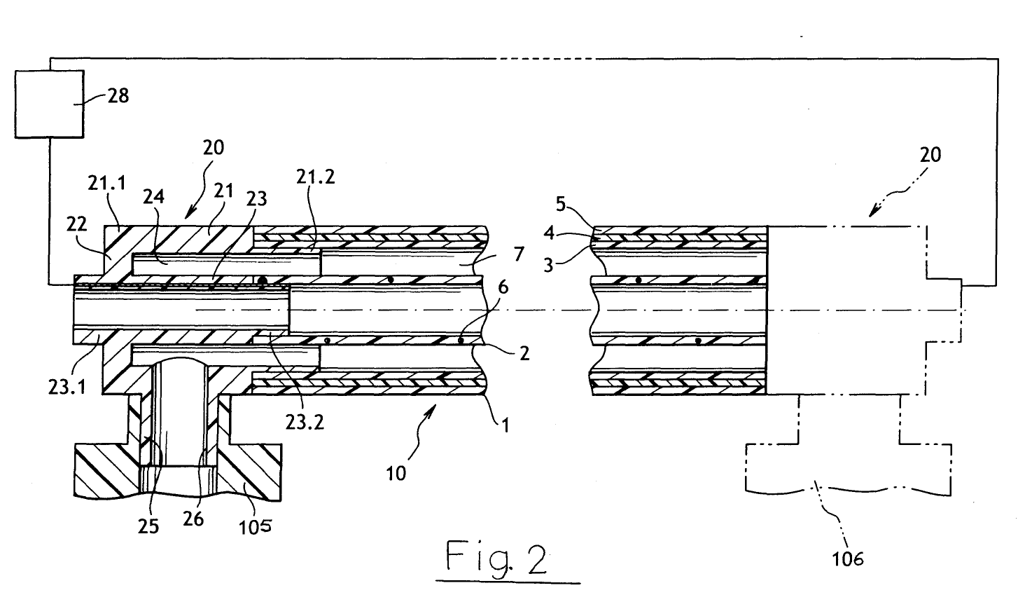

### DETAILED DESCRIPTION OF THE INVENTION

With reference to the figures, the vehicle in accordance with the invention (represented diagrammatically in chain-dotted lines) comprises in conventional manner an internal combustion engine 100 having an admission line 101 and an exhaust line 102 provided with a catalyst 103 operating using selective catalyst reduction (SCR) in known manner.

A pollution-reducer device 104 is fitted to the exhaust line 102. The pollution-reducer device 104 comprises a tank 105 connected by a first pipe 10 to a metering member 106, itself connected by a second pipe 10 to an injector member 107 delivering in conventional manner into the catalyst 103.

The tank 105 contains a depollution fluid here comprising a mixture of urea and water respectively in proportions of about 30% and 70%. By way of example, such a fluid is sold under the trademark Adblue by the supplier Greenchem.

The metering member 106 controls delivery of the necessary quantity of depollution fluid to the injector. The metering member is itself known and in particular it incorporates a metering pump and a control unit.

The injector member 107 of conventional structure serves to introduce the depollution fluid into the catalyst 103, possibly together with air, in quantities determined by the metering member 106.

Each pipe 10 is rigid and shaped by thermoforming to have a shape that enables it to be installed in the pollution-reducer device 104.

Each pipe 10 comprises an outer tube 1 and an inner tube 2, here extending coaxially within the outer tube 1. The outer tube 1 and the inner tube 2 have respective inside and outside diameters so as to leave a fluid flow space 7 between them.

The outer tube 1 is a multilayer tube comprising an inner layer 3 of high density polyethylene, an intermediate layer 4 of maleic anhydride grafted polyethylene, and an outer layer 5 of polyamide. The outer tube 1 could be of a different structure, and for example it could be a single layer tube comprising a layer of a thermoplastic material such as a polyamide, a polyethylene, or a mixture of polypropylene and ethylene-propylene-diene monomer.

In this example, the inner tube 2 is a single layer tube made of a thermoplastic material, more particularly a mixture of polypropylene and ethylene-propylene-diene monomer. The inner tube 2 may also be made of elastomer, and more particularly of an elastomer that incorporates silicone.

The inner tube 2 is more flexible than the outer tube 1. The flexibility and the thermal behavior of the inner tube 2 are such that the inner tube 2 is deformable at low temperature. The inner tube 2 must thus retain its flexibility at temperatures lower than −7° C.

The materials used present the advantage of being inexpensive. The material of the inner tube 2 and of the inner layer 3 are compatible with the transported fluid, i.e. they withstand it chemically.

In its thickness, the inner tube 2 also incorporates a heater element 6, in this example a metal wire extending helically in the material of the inner tube 2, and suitable for being connected to an electrical power supply so as to heat the fluid flowing in the pipe 10. In a variant, the heater element 6 could be a braid or a tape or any other resistive element made of a material that is suitable for heating on being subjected to a voltage.

The pipe 10 of the invention is made by coextrusion.

The first pipe 10 is connected to the tank 105 and to the metering member 106 (forming elements of the depollution fluid transport circuit) via couplings secured to the ends of the pipe 10 and given overall reference 20.

Each coupling 20 comprises a tubular body 21 having one end 21.1 closed by a radial partition 22, and an opposite end 21.2 arranged to be engaged in the corresponding end of the outer tube 1.

A bushing 23 extends coaxially inside the body 21. The bushing 23, likewise of tubular shape, has one end 23.1 connected to the body 21 by the partition 22, and an opposite end 23.2 arranged to be engaged in the corresponding end of the inner tube 2. The end 23.1 is open to the outside of the coupling 20. The bushing 23 incorporates an electrical conductor 27 leading to the outside at the end 23.2 so as to be put into contact with one element of the heater element, and at the end 23.1 so as to be connected to an electrical power supply 28 of conventional kind. On a motor vehicle, the power supply 28 may be the battery of the vehicle. The heater element 6 may alternatively be connected to the power supply 28 by using any type of electrical connection.

The bushing 23 and the body 21 define an annular space 24 in communication with the space 7 when the pipe 10 is connected to the coupling 20.

The coupling 20 includes an endpiece 25 that projects radially from the body 21 and defines a channel 26 in communication with the annular space 24. The endpiece 25, of conventional shape, is engaged in the circuit element 105, 106. The endpiece 25 may be in the form of a serrated spigot, or a teat, or it may be smooth, or fitted with screw/nut type connection means.

The connection of the second tube to the metering member 106 and to the injector member 107 is likewise provided by couplings 20.

When the temperature drops below the temperature at which the fluid solidifies, the fluid freezes and its volumes increases. The expansion of the fluid exerts pressure on the outer tube 1 and on the inner tube 2. because of its flexibility, the inner tube 2 deforms by being compressed, and possibly even by collapsing so as to absorb the expansion of the fluid without leading to excessive pressure on the outer tube 1. The air contained in the inner tube 2 can be evacuated through the end 23.1 thereof which is open. Specifically, the end 23.1 allows air to pass freely from the outside to the inside, and vice versa. Thus, the outside diameter of the tube does not vary, thus making it easier to put into place and to hold in position in the vehicle. The heater element 6 serves to liquefy the fluid while consuming relatively little energy, given its disposition inside the pipe and very close to the fluid.

By way of example, it is assumed that the pipe must be capable of accommodating an expansion of 20% by the fluid. For a flow space 7 having a section of 100 square millimeters (mm²) (referred to as the hydraulic section or the flow section of the pipe), the hydraulic section must be capable of increasing up to 120 mm². The inner tube then has a hydraulic section of 40 mm², for example: the necessary increase in the hydraulic section of the pipe can be achieved with the inner tube having a compressibility ratio of 50%. It would also be possible to accommodate the fluid expanding by 40%, since a corresponding increase in the hydraulic section of the pipe would result in the inner tube collapsing completely. Naturally, the pipe could be dimensioned in some other way.

In a particular embodiment, the outer tube has a thickness lying in the range 1 millimeter (mm) to 1.4 mm, approximately, and the inner tube has a thickness lying in the range 0.4 mm to 0.6 mm, approximately.

Naturally, the invention is not limited to the embodiment described, and variants can be applied thereto without going beyond the ambit of the invention as defined by the claims.

In particular, at its ends, the pipe may include spacers holding the inner and outer tubes apart. The inner tube may be closed at its ends. The inner tube need not be coaxial with the outer tube. The compressible member may be of a shape different from that of a tube, and it could comprise a cylinder of cellular material. It is possible to act on the compressibility of a gas contained in the cells.

The shape of the ends 21.1 and 23.2 could be corrugated, serrated, teat-shaped, . . . .

Although the pipe is shown having its ends fitted with couplings 20 that are identical, air may flow in and out of the inner tube 2 via one end only, and the same can apply to the electrical connection with the heater element 6 if the ends thereof can be brought out at a single end of the inner tube 1.

The heater element incorporated in the inner tube 2 may also be backed up by a heater element incorporated in the outer tube 1, or it could be omitted if the outer tube has a heater element. The heater element could be provided around the outer tube 1. The heater element is optional.

The coupling 20 could be of a structure different from that described, and for example it could be arranged to engage on the inner and outer tubes instead of in them.

What is claimed is:

1. A pollution-reducer device comprising a tank of depollution fluid connected by a pipe to an injector member for injecting the fluid into a catalyst of a burnt-gas exhaust line, wherein the pipe comprises an outer tube receiving a compressible member that is compressible by a ratio that is suitable for compensating an increase in pressure exerted by the fluid on the pipe.

2. A device according to claim 1, in which the compression ratio is adapted to compensate for an expansion of the fluid.

3. A device according to claim 1, in which the pipe includes an inner tube extending coaxially inside the outer tube, the inner and outer tubes having diameters suitable for leaving a fluid flow space between them, the inner tube having an outside surface that is compatible with the transported fluid and the inner tube being more flexible than the outer tube so as to deform in order to compensate for an expansion of the fluid.

4. A device according to claim 3, in which the inner tube is made of a thermoplastic material.

5. A device according to claim 4, in which the thermoplastic material of the inner tube comprises polypropylene and ethylene-propylene-diene monomer.

6. A device according to claim 3, in which the inner tube is made of elastomer material.

7. A device according to claim 6, in which the elastomer of the inner tube is based on silicone.

8. A device according to claim 1, in which the outer tube is made of thermoplastic material.

9. A device according to claim 8, in which the thermoplastic material of the outer tube is selected from amongst the following materials: polyethylene; polyamide; and a mixture of polypropylene and ethylene-propylene-diene monomer.

10. A device according to claim 8, in which the outer tube comprises an inner layer of high density polyethylene, an intermediate layer of maleic anhydride grafted polyethylene, and an outer layer of polyamide.

11. A device according to claim 1, in which the pipe includes a resistive heater element.

12. A device according to claim 1, in which the compressible member is arranged to absorb an expansion resulting from the fluid solidifying at low temperature.

13. A device according to claim 1, in which the fluid comprises urea, and the pipe is made of a thermoplastic material constituting a barrier to urea and to at least one product that results from decomposition of the urea, and has an inside surface that withstands urea chemically and at least one product that results from decomposition of urea.

14. A device according to claim 3, having ends connected to circuit elements in such a manner that the fluid flows in the flow space extending between the tubes while the inner tube is open.

15. A device according to claim 14, in which at least one of the ends of the pipe is fitted with a coupling comprising a tubular body having one end arranged to co-operate with the corresponding end of the outer tube, and an opposite end closed by a radial partition, a bushing extending coaxially inside the body and having one end secured to the partition and opening to the outside of the coupling, and an opposite end arranged to co-operate with the corresponding end of the inner tube in such a manner as to put the flow space of the pipe into communication with an annular space defined by the body and the bushing, the coupling including coupling means for connecting said annular space with the element.

16. A device according to claim 15, wherein the coupling means comprise an endpiece projecting radially from the body.

17. A motor vehicle having a combustion engine with a burnt-gas exhaust line provided with a catalyst and a pollution-reducer device in accordance with claim 1.

18. A pipe for a pollution-reducer device according to claim 1.

19. A pipe according to claim 18, arranged to be rigid and shapeable by thermoforming.
